(19) United States
(12) Patent Application Publication
(10) Pub. No.: US 2019/0318687 A1
(43) Pub. Date: Oct. 17, 2019

(54) METHOD FOR PROTECTING OLED SCREEN, OLED SCREEN PROTECTING SYSTEM, AND OLED DISPLAY

(71) Applicant: SHENZHEN ROYOLE TECHNOLOGIES CO. LTD., Shenzhen, Guangdong (CN)

(72) Inventor: Ji WANG, Shenzhen, Guangdong (CN)

(21) Appl. No.: 16/314,634

(22) PCT Filed: Sep. 27, 2016
(86) PCT No.: PCT/CN2016/100326

§ 371 Date: Dec. 31, 2018

(51) Int. Cl. G09G 3/3208

(52) U.S. Cl. CPC G09G 3/3208; G09G 2320/0257; G09G 2380/02; G09G 2330/027; G09G 2330/04

(57) ABSTRACT

A method for protecting an OLED screen, operated to protect a screen of an OLED display, is provided by the present disclosure. The method for protecting the OLED screen includes sampling a screen signal of the OLED screen (S101); detecting a change of the screen signal, when a period of the detected screen signal remaining unchanged or changing periodically in a first preset period is greater than a second preset period, output a control signal, in which the first preset period is greater than the second preset period (S102); and controlling the OLED screen to restart according to the control signal (S103), thus avoiding the situation that an image of the OLED screen is unchanged or periodically changed for a long time, solving the problem appearing an ghosting image on the OLED screen, without adding any hardware components and hardware circuits, and thereby reducing the cost.

### RELATED APPLICATION

The present application is a National Phase of International Application Number PCT/CN2016/100326, filed Sep. 27, 2016.

### TECHNICAL FIELD

The application relates to the field of electronic communications, more particularly relates to a method for protecting an OLED screen, an OLED screen protecting system, and an OLED display.

### BACKGROUND

The current organic light emitting diodes (OLEDs) have a problem of luminance attenuation. Moreover, due to the display content, the brightness of the always-bright area is greatly attenuated, often leaving a ghosting image commonly known as “burn-in”, thus becoming a defect of the OLED display screen. Currently, in order to solve the problem of the luminance attenuation of the OLED, many solutions have been proposed, but some of these solutions compensate the luminance attenuation of a display unit by adding hardware components into designed circuit. However, in order to pursue high-quality display effects, the pixel density is getting higher and higher, and there are extremely high demands for manufacturing process to arrange complex circuits in a small space, thus causing a low yield.

### SUMMARY

An exemplary embodiment of the present disclosure provides a method for protecting an OLED screen to protect a screen and prevent a ghosting image appeared on the screen.

An exemplary embodiment of the present disclosure provides a method for protecting an organic light emitting diode (OLED) screen, operated to protect a screen of an OLED display. The method for protecting the OLED screen includes:

sampling a screen signal of the OLED screen;

detecting a change of the screen signal, when a period of the detected screen signal remaining unchanged or changing periodically in a first preset period is greater than a second preset period, output a control signal, in which the first preset period is greater than the second preset period; and

controlling the OLED screen to restart according to the control signal.

In an alternative exemplary embodiment, the method further includes returning to the operation of the sampling a screen signal of the OLED screen, when the period of the detected screen signal remaining unchanged or changing periodically in the first preset period is less than or equal to the second preset period.

In an alternative exemplary embodiment, the operation of controlling the OLED screen to restart according to the control signal includes:

outputting a start signal to the OLED screen according to the control signal to restart the OLED screen; or

outputting a start signal to a system of the OLED display according to the control signal, to make the system to restart the OLED screen.

In an alternative exemplary embodiment, the screen signal includes a data signal or a clock signal.

In an alternative exemplary embodiment, the control signal is a high level signal or a low level signal.

An exemplary embodiment of the present disclosure provides an OLED screen protecting system, operated to protect a screen of an OLED display. The OLED screen protecting system includes a sampling unit, a detecting unit, and a control unit, the sampling unit is operated to sample a screen signal of the OLED screen; the detecting unit is operated to detect a change of the screen signal, and operated to output a control signal when a period of the detected screen signal remaining unchanged or changing periodically in a first preset period is greater than a second preset period, in which the first preset period is greater than the second preset period; and the control unit is operated to control the OLED screen to restart according to the control signal.

In an alternative exemplary embodiment, the detecting unit is further operated to return to the operation of the sampling a screen signal of the OLED screen, when the period of the detected screen signal remaining unchanged or changing periodically in the first preset period is less than or equal to the second preset period.

In an alternative exemplary embodiment, the control unit is further operated to output a start signal to the OLED screen according to the control signal to restart the OLED screen; or operated to output a start signal to a system of the OLED display according to the control signal, to make the system to restart the OLED screen.

In an alternative exemplary embodiment, the screen signal includes a data signal or a clock signal.

An exemplary embodiment of the present disclosure provides an OLED display, including an OLED screen and the above OLED screen protecting system, and the OLED screen protecting system is operated to protect the OLED screen.

A method for protecting an organic light emitting diode (OLED) screen, operated to protect a screen of an OLED display, is provided by the present disclosure. The method for protecting the OLED screen includes sampling a screen signal of the OLED screen; detecting a change of the screen signal, and outputting a control signal when a period of the detected screen signal remaining unchanged or changing periodically in a first preset period is greater than a second preset period, output a control signal, in which the first preset period is greater than the second preset period; and controlling the OLED screen to restart according to the control signal. The method for protecting the OLED screen, the OLED screen protecting system, and the OLED display of the present disclosure avoid the situation that an image of the OLED screen is unchanged or periodically changed for a long time, solve the problem appearing a ghosting image on the OLED screen, and do not add any hardware components and hardware circuits, thus reducing the cost.

### BRIEF DESCRIPTION OF THE DRAWINGS

In order to more clearly illustrate the technical solutions in the exemplary embodiments of the present disclosure, the accompanying drawings used in the description of the exemplary embodiments will be briefly described below. Obviously, the accompanying drawings in the following description are only some embodiments of the present disclosure, those skilled in the art can also obtain other drawings based on these drawings without paying any creative work.

FIG. 1 is a flowchart of a method for protecting an OLED screen provided by an exemplary embodiment of a first scheme of the present disclosure.

FIG. 2 is a block diagram of an OLED screen protecting system provided by an exemplary embodiment of a second scheme of the present disclosure.

FIG. 3 is a block diagram of an OLED display provided by an exemplary embodiment of a third scheme of the present disclosure.

### DETAILED DESCRIPTION

The technical solutions in the in the exemplary embodiments of the present disclosure will be clearly and completely described below in conjunction with the accompanying drawings of the exemplary embodiments of the present disclosure.

As illustrated FIG. 1, an exemplary embodiment of a first scheme of the present disclosure provides a method for protecting an OLED screen. The method for protecting an OLED screen includes the following operations.

At block S101, a screen signal of the OLED screen is sampled.

It is to be noted that, the screen signal includes a plurality of data signals or a plurality o'clock signals. In an exemplary embodiment, the screen signal includes one data signal or one clock signal.

At block S102, a change of the screen signal is detected, when a period of the detected screen signal remaining unchanged or changing periodically in a first preset period is greater than a second preset period, output a control signal, in which the first preset period is greater than the second preset period.

It is to be noted that, the first preset period is defined as one sampling time. The screen signal remaining unchanged may be a condition that the screen signal is a high level signal or a low level signal. The period of the detected screen signal remaining unchanged or changing periodically in the first preset period is greater than the second preset period, indicating that a screen image of the OLED display is unchanged for a long time, thus generating a ghosting image on the screen of the OLED display. Intervention is required. When the period of the detected screen signal remaining unchanged or changing periodically in the first preset period is less than or equal to the second preset period, the process returns to the operation at S101.

At block S103, the OLED screen is controlled to restart according to the control signal.

When the screen of the OLED display appearing to have the ghosting image needs to be interfered, the OLED screen may be controlled to restart to avoid the phenomenon of the ghosting image appearing on the screen.

It is to be noted that, the operation of the controlling the OLED screen to restart may be performed in two ways. One way is to directly send the control signal to the OLED screen to restart the OLED screen according to the control signal. The other way is to send the control signal to a system of the OLED display, thus causing the system to control the OLED screen to restart according to the control signal. The operation at block S103 includes: outputting start signal to the OLED screen according to the control signal to restart the OLED screen; or outputting a start signal to a system of the OLED display according to the control signal, to make the system to restart the OLED screen.

In an exemplary embodiment, the method for protecting the OLED screen includes sampling a screen signal of the OLED screen; detecting a change of the screen signal, when a period of the detected screen signal remaining unchanged or changing periodically in a first preset period is greater than a second preset period, output a control signal, in which the first preset period is greater than the second preset period; and controlling the OLED screen to restart according to the control signal. The method for protecting the OLED screen of the present disclosure avoids the situation that an image of the OLED screen is unchanged or periodically changed for a long time, solves the problem appearing ghosting image on the OLED screen, and does not add any hardware components and hardware circuits, thus reducing the cost.

It is to be noted that, since the screen signals includes the plurality of data signals and the plurality of clock signals, the screen signals are shunted. Each branch corresponding to onscreen signal. A detecting process of the screen signals of each branch is the same. The detecting process includes the above operations at S101 to S103. All of the screen signals are detected, such that the ghosting image appeared on the screen of the OLED display may be more effectively avoided.

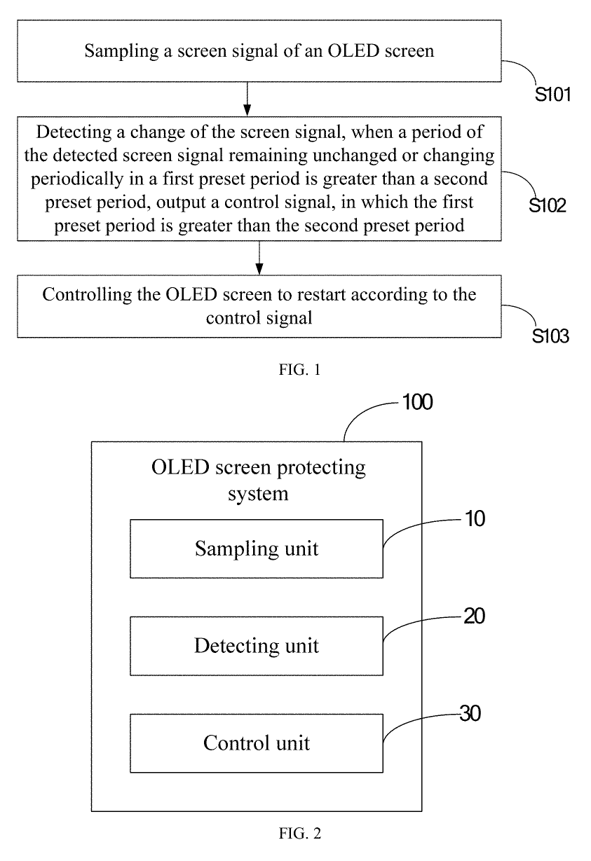

As illustrated FIG. 2, an exemplary embodiment of second scheme of the present disclosure provides an OLED screen protecting system. The OLED screen protecting system 100 includes a sampling unit 10, a detecting unit 20, and a control unit 30. The sampling unit 10 is operated to sample a screen signal of the OLED screen. The detecting unit 20 is operated to detect a change of the screen signal, and operated to output a control signal when a period of the detected screen signal remaining unchanged or changing periodically in a first preset period is greater than a second preset period output a control signal, in which the first preset period is greater than the second preset period. The control unit 30 is operated to control the OLED screen to restart according to the control signal.

It is to be noted that, the screen signal includes a plurality of data signals or a plurality of clock signals. In an exemplary embodiment, the screen signal includes one data signal or one clock signal. The first preset period is one sampling time. The screen signal remaining unchanged may be a condition that the screen signal is a high level signal or a low level signal. The period of the detected screen signal remaining unchanged or changing periodically in the first preset period is greater than the second preset period, indicating that a screen image of the OLED display is unchanged for a long time, thus generating a ghosting image on the screen of the OLED display. Intervention is required. When the screen of the OLED display appearing the ghosting image needs to be interfered, the OLED screen may be controlled to restart to avoid the phenomenon of the ghosting image appearing on the screen. The operation of the controlling the OLED screen to restart may be performed in two ways. One way is to directly send the control signal to the OLED screen to restart the OLED screen according to the control signal. The other way is to send the control signal to a system of the OLED display, thus causing the system to control the OLED screen to restart according to the control signal. Therefore, the control unit 30 is operated to output start signal to the OLED screen according to the control signal to restart the OLED screen; or operated to output a start signal to a system of the OLED display according to the control signal, to make the system to restart the OLED screen.

Furthermore, when the period of the detected screen signal remaining unchanged or changing periodically in the first preset periodic less than or equal to the second preset period, the detecting unit 20 is further operated to output the sample signal to the sampling unit 10, to make the sampling unit 10 to sample the screen signal of the OLED screen.

In an exemplary embodiment, the OLED screen protecting system 100 includes the sampling unit 10, the detecting unit 20, and the control unit 30. The sampling unit 10 is operated to sample a screen signal of the OLED screen. The detecting unit 20 is operated to detect a change of the screen signal, and operated to output a control signal when a period of the detected screen signal remaining unchanged or changing periodically in a first preset period is greater than a second preset period, in which the first preset period is greater than the second preset period. The control unit 30 is operated to control the OLED screen to restart according to the control signal. Therefore, the OLED screen protecting system 100 of the present disclosure avoids the situation that an image of the OLED screen is unchanged or periodically changed for a long time, and solves the problem appearing a ghosting image on the OLED screen, and does not add any hardware components and hardware circuits, thus reducing the cost.

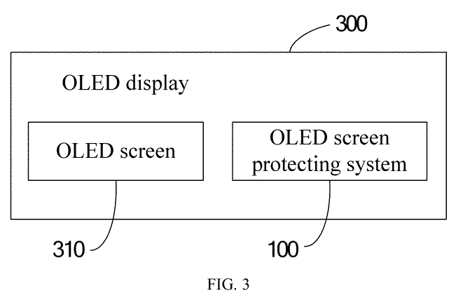

As illustrated FIG. 3, an exemplary embodiment of third scheme of the present disclosure provides an OLED display 300. The OLED display 300 includes an OLED screen 310 and an OLED screen protecting system. The OLED screen protecting system is operated to protect the OLED screen 310. The OLED screen protecting system is the OLED screen protecting system 100 provided by the above exemplary embodiment. Since the OLED screen protecting system 100 is described in detail in the second scheme described above, it will not be described herein.

In an exemplary embodiment, the OLED display 300 includes the OLED screen 310 and the OLED screen protecting system 100. The OLED screen protecting system 100 includes the sampling unit 10, the detecting unit 20, and the control unit 30. The sampling unit 10 is operated to sample a screen signal of the OLED screen. The detecting unit 20 is operated to detect a change of the screen signal, and operated to output a control signal when a period of the detected screen signal remaining unchanged or changing periodically in a first preset period is greater than a second preset period, in which the first preset period is greater than the second preset period. The control unit 30 is operated to control the OLED screen to restart according to the control signal. Therefore, the OLED display 300 of the present disclosure avoids the situation that an image of the OLED screen 310 is unchanged or periodically changed for a long time, solving the problem of appearing a ghosting image on the OLED screen 310, and does not add any hardware components and hardware circuits, thus reducing the cost.

The above disclosure is only the preferred embodiment of the present disclosure. It should be noted that those skilled in the art can also make several improvements and polish without departing from the principles of the present disclosure. These improvements and polish are also considered as the scope of the disclosure.

What is claimed is:

1. A method for protecting an organic light emitting diode (OLED) screen, operated to protect a screen of an OLED display, and wherein the method for protecting the OLED screen comprises:
sampling screen signal of the OLED screen;
detecting a change of the screen signal, when a period of the detected screen signal remaining unchanged or changing periodically in a first preset period is greater than a second preset period, output a control signal, in which the first preset period is greater than the second preset period; and
controlling the OLED screen to restart according to the control signal.

2. The method for protecting the OLED screen of the claim 1, wherein the method further comprises: returning to the operation of the sampling a screen signal of the OLED screen, when the period of the detected screen signal remaining unchanged or changing periodically in the first preset periodic less than or equal to the second preset period.

3. The method for protecting the OLED screen of the claim 1, wherein the operation of controlling the OLED screen to restart according to the control signal comprises:
outputting a start signal to the OLED screen according to the control signal to restart the OLED screen; or
outputting a start signal to a system of the OLED display according to the control signal, to make the system to restart the OLED screen.

4. The method for protecting the OLED screen of the claim 1, wherein the screen signal comprises a data signal or a clock signal.

5. The method for protecting the OLED screen of the claim 1, wherein the control signal is a high level signal or a low level signal.

6. Anole screen protecting system, operated to protect a screen of an OLED display, wherein the OLED screen protecting system comprises sampling unit, a detecting unit, and a control unit, the sampling unit is operated to sample a screen signal of the OLED screen; the detecting unit is operated to detect a change of the screen signal, and operated to output a control signal when a period of the detected screen signal remaining unchanged or changing periodically in a first preset period is greater than a second preset period, in which the first preset period is greater than the second preset period; and the control unit is operated to control the OLED screen to restart according to the control signal.

7. The OLED screen protecting system of the claim 6, the detecting unit is further operated to return to the operation of the sampling a screen signal of the OLED screen, when the period of the detected screen signal remaining unchanged or changing periodically in the first preset periodic less than or equal to the second preset period.

8. The OLED screen protecting system of the claim 6, wherein the control unit is further operated to output start signal to the OLED screen according to the control signal to restart the OLED screen; or operated to output a start signal to a system of the OLED display according to the control signal, to make the system to restart the OLED screen.

9. The OLED screen protecting system of the claim 6, wherein the screen signal comprises a data signal or a clock signal.

10. An OLED display, comprising an OLED screen and the OLED screen protecting system of claim 6, the OLED screen protecting systemic operated to protect the OLED screen.
